(19) United States
(12) Patent Application Publication
(10) Pub. No.: US 2002/0162118 A1
(43) Pub. Date: Oct. 31, 2002

(54) Efficient interactive TV

(76) Inventors: Kenneth L. Levy, Stevenson, WA (US); Tony F. Rodriguez, Portland, OR (US); R. Stephen Hiatt, Portland, OR (US)

Correspondence Address: DIGIMARC CORPORATION, 19801 SW 72ND AVENUE, SUITE 100, TUALATIN, OR, 97062, US

(21) Appl. No.: 10/060,049

(22) Filed: Jan. 28, 2002

Related U.S. Application Data
(60) Provisional application No. 60/265,392, filed on Jan. 30, 2001.
(60) Provisional application No. 60/270,782, filed on Feb. 20, 2001.
(60) Provisional application No. 60/276,543, filed on Mar. 15, 2001.

(51) Int. Cl. H04N 7/173

(52) U.S. Cl. 725/110; 725/112

(57) ABSTRACT

Content identifiers are provided to uniquely identify content, or a subset of the content. The content identifiers are used to index corresponding interactive data. The interactive data may be maintained in a central base, or may be distributed to routers in various subsets. In one embodiment, a set-top box receives content in an interactive television system. The content is digitally watermarked to include content identifiers. The set-top box includes a watermark decoder, which detects the watermark identifier. The identifier is used to access information, such as interactive data. The interactive data is then used to access interactive content. In another embodiment, interactive data and/or content are pushed to the set-top box. In addition, the context of the situation can be communicate to improve the interactive experience.

### RELATED APPLICATION DATA

This application claims the benefit of U.S. Provisional Application Nos. 60/265,392, filed Jan. 30, 2001, 60/270,782, filed Feb. 20, 2001, and 60/276,543, filed Mar. 15, 2001. Each of these applications is herein incorporated by reference.

The subject matter of the present application is also related to that disclosed in assignee's U.S. patent application Ser. Nos. 09/597,209, filed Jun. 20, 2000, 09/660,756, filed Sep. 13, 2000, and 10/002,225, filed Nov. 20, 2001, and U.S. Pat. No. 6,122,403. Each of these patent documents is herein incorporated by reference.

### FIELD OF THE INVENTION

The present invention relates to using content identifiers with interactive television systems, and is particularly illustrated in the context of digital watermarking.

### BACKGROUND AND SUMMARY OF THE INVENTION

Interactive television (hereinafter “iTV”) is a convergence between television and computers. iTV allows consumers to become more involved with content, thus encouraging a consumer to interact with a channel longer. iTV also allows TV content, like commercials, to interactively sell products. For example, pizza can be ordered while watching a pizza commercial with a click of a remote or interactive mouse.

One key component of iTV systems is a data channel, which accompanies the TV audio/video. Numerous techniques have been proposed to provide a data channel—the most common of which is to encode data in the vertical blanking interval (VBI) of traditional analog TV signals, examples of which are closed caption, Teletext and ATVEF. Techniques that are commonly used with NTSC sometimes do not typically find favor with PAL systems, and vice versa.

One enhanced video programming system is discussed in U.S. Pat. No. 6,018,768, issued on Jan. 25, 2000, and incorporated herein by reference. The 6,018,768 Patent discusses a computer-based system, which receives a video program with embedded uniform resource locators (URLs). The URLs (i.e., the effective addresses of locations or Web sites on the Internet) are interpreted by the disclosed system to the Web site locations to retrieve related Web pages. According to the 6,018,768 Patent, upon receipt of the Web pages by the system, the Web pages are synchronized to the video content for display.

Much work has been done in recent years in the field of video digital watermarking—the science of conveying data through slight changes to the video information presented to the viewer (“in-band”). The changes are preferably slight as to be imperceptible to the viewer, yet can be recovered by suitable signal processing. Illustrative techniques are shown in the assignee's U.S. Pat. No. 6,122,403 and U.S. application Ser. Nos. 09/138,061 and 09/164,859, and in patent documents WO99/45705, WO 00/04722, each of which are hereby incorporated by reference. Of course, other techniques can be used to steganographically embed data within a video signal. Such embedding techniques are suitably interchangeable with the present invention.

The focus of prior art video watermarking efforts primarily has been to implement copy control functionality (e.g., to assure that copyrighted DVD video is not copied) and to provide some ownership marking of video content.

Digital watermark technology, however, may be extended to provide additional data (e.g., serve as a data channel) in an iTV system, sometimes referred to as the trigger. If the system relies on a consumer's set-top box (STB) or other computer to perform some of the system processing, the watermark processing operations can likewise be performed by the STB (or computer). Existing iTV systems can be modified to utilize a digital watermark communications channel by providing the requisite digital watermark processing function at a suitable layer in known iTV stack architectures.

One feature typically included in a STB is a return (or “back”) channel. A back channel is typically used to send requests for and/or to receive interactive data or content, as defined below. Current iTV systems have limited bandwidth for a return channel, especially with cable systems where many users (e.g., 500 to 2000) share a limited return channel (e.g., a 10 Mbps channel). Such restrictive bandwidth may limit overall system interactivity. Other TV systems may require a plain old telephone service (POTS) 56 kbps or less connection.

Interactive television systems can also interact other devices, such as analog video recorders (e.g., VCRs), digital personal video recorders (PVRs), generic STBs, satellite input, receivers, audio systems, and/or DVD players. The back channel alternatively can be provided via such other devices. A desirable feature is that the content creator, content owner, distributor, or any other involved in the path of the content from creation to the end user can influence the iTV experience.

One emerging standard used in advanced television systems (and certain set top boxes) is known as ATVEF (Advanced Television Enhancement Forum—see www.atvef.com). Through this standard, video content can be produced once (using a variety of different tools), and can thereafter be distributed and displayed in a variety of environments (e.g., analog & digital, cable and satellite distribution; display using STBs, digital TVs, analog TVs, PCs, etc.). ATVEF is built on a number of other standards, including HTML 4.0, EcmaScript 1.1, and Multicast IP. In more technical jargon, ATVEF is a declarative content specification with scripting. Several familiar broadcast programs already employ this technology, including Wheel of Fortune, and Jeopardy, to enhance the viewer experience. The AOL-TV is based on ATVEF-compliant technology.

ATVEF sends triggers over vertical blanking interval (VBI) line 21 with close captioning text, such that the trigger can be used to connect the user to interactive information, such as a standard World Wide Web (WWW) page. The trigger is currently the link defined as text, such as a standard uniform resource locator (URL). This text may be considered a disadvantage because it consumes 7 or 8 bits per letter, depending upon whether you are using standard or extended ASCII.

The present invention provides an improved approach, which is to include content identifiers (and/or context information) with content. The content identifiers are preferably sent to a database, such as maintained by a remote server, a local cache, or distributed router, to interpret and enable corresponding interactivity. A content identifier is efficient since the interactive data is maintained separately. The context information could include identifiers of participants involved in the content's value chain (e.g., such as participants involved from content creation to distribution) and be added by the device that detects the content identifiers. The content ID can be added to the content via VBI line 21 as done with ATVEF, but is preferably embedded within the content via digital watermarking technology, or other known steganographically embedding method.

The advantages of this improved approach are significant. Fewer bits are sent over a back channel, increasing revenue return on the back channel for the distributor. The entire interactive system is easier to manage since a central server (or distributed servers) contains the links to the interactive data. Associating an identifier also allows data stored in a corresponding database to be altered or updated, without changing the identifier. Moreover, the unique identifier may still provide features such as content protection, copyright control and content usage.

The foregoing and other features and advantages of the present invention will be even more apparent from the following detailed description, which proceeds with reference to the accompanying drawings.

### BRIEF DESCRIPTION OF THE DRAWINGS

FIG. 1 provides a block diagram overview of an interactive television system.

FIG. 2 is a block diagram illustrating a set-top box.

FIG. 3 is a functional block diagram of an interactive television system.

FIGS. 4-6 are functional block diagrams of interactive television systems having distributed routers.

FIG. 7 is a functional block diagram of an interactive television system having distributed redirection maps.

FIG. 8 is a functional block diagram of an interactive television system having a cached redirect table located in a consumer's set-top box.

FIGS. 9 and 10 are functional block diagrams illustrating a push system for an interactive television system.

FIG. 11 is a functional block diagram that illustrates an interactive television system using content identifiers.

FIG. 12 is a block diagram illustrating a set-top box as a central decoder.

FIG. 13 is a functional block diagram illustrating a data flow in one embodiment of an interactive television system.

FIG. 14 is a functional block diagram illustrating another embodiment of an interactive television system.

FIG. 15 is a functional block diagram illustrating alternative implementations of the FIG. 14 embodiment.

FIG. 16 is a functional block diagram illustrating still another embodiment of an interactive television system.

### DETAILED DESCRIPTION

For illustrative purposes, the present invention is described with respect to interactive television systems (“iTV systems”). However, as will be appreciated by those skilled in the art, the concepts of the present invention may be readily applied to other systems and environments, such as enhanced distribution systems, networking systems, internet related systems, etc.

Overview

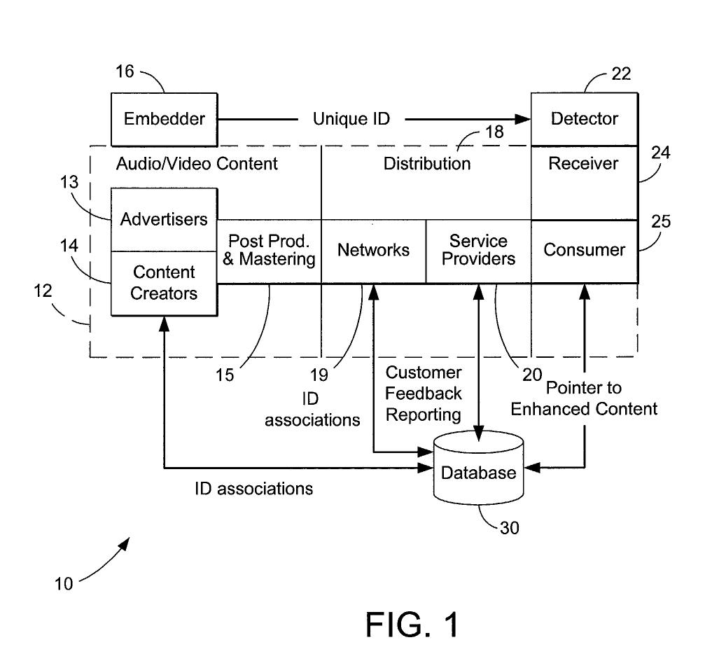

FIG. 1 provides an overview of an inventive interactive television system. Content (or a content item) is created 12 for distribution 18 (e.g., supply, broadcast, multicast, etc). The term “content” is defined broadly herein to include audio, video, text, graphics, and/or still images. Content may also include audio signals, video signals, text, movies, commercials, advertisements, programming (both TV and computer programming), scripting, and so forth. The term content may also include interactive content as discussed below. Content creators 14 create content items. For example, a film or television studio (e.g., a content creator) produces a movie, drama, sit-com or news-program, e.g., the content item.

Advertisers 13 also create content (e.g., advertisements, messages, promotions, etc.). Such advertisements may be inserted in or otherwise combined with other content.

Post-production and mastering processes ready the content and advertisements for distribution.

An identifier is preferably associated with each content item (including advertisements). Preferably, an identifier uniquely identifies a content item. For example, a sit-com episode includes a unique identifier. A content item may also be subdivided into sets, and a unique identifier is associated with each subset. For example, particular scenes, commercial segments, and/or video frames may each include unique identifiers. Particular objects within video frames also may be associated with a unique identifier. For example, a Coke can in a frame, or series of frames, can be associated with a unique identifier. Similarly, the content identifier optionally may include a unique identifier and time code, which can be used to identify the content and section of the content, such as the lapsed seconds of a movie since the start. This format enables efficient database design since every section of the content identified with one identifier and the timing is a secondary field in the database.

As shown in the FIG. 1 embodiment, an embedder 16 is provided to embed content with digital watermarks. A digital watermark may include a unique identifier (or identifiers) in a payload, message or other watermark components. The watermark itself may alternatively serve as the content identifier. There are many suitable digital watermarking techniques known to those of ordinary skill in the art, and such techniques may be suitably employed with the present invention, so long as the technology provides data carrying capacity to accommodate a content identifier. Digital watermarking may also be used in connection with VBI line insertion, object marking, frame numbering, fingerprinting (a.k.a., robust hashing), digital signatures, binary identifiers, other embedding, etc. (In some case, a content identifier is carried by these other techniques.).

When a unique content identifier (ID) is used in a VBI line, the advantages over ATVEF, which standardize a web site URL or IP address in the VBI line are numerous. Many will be described below involving specific discussions of using digital watermarks and IDs, but are applicable to IDs in VBI lines. For example, by using an ID, less space in VBI line 21 and a back channel is used to communicate with the head-end. In addition, the action can be changed by updating the link in the database, which enables the action to be dependent upon context, such as a service provider, time of day, number of times that the consumer has selected that item, and so on.

The content identifiers are maintained in database 30. The content identifiers can be linked to additional information in the database 30. In one embodiment, database 30 facilitates mapping of content identifiers (and/or context information) to interactive data, and in some cases, mapping of content identifiers and context information directly to interactive content. For this discussion, interactive data includes information used to reference, index, find, point to, address, or otherwise define interactive content associated with the broadcast content. Interactive content preferably includes content rendered on an end-user's device in response to a request by a user (e.g., HTML pages, Java applets, text, graphics, etc., etc.). One example of interactive data is a URL, pointer or IP address, which is associated with the particular content.

To illustrate this process, an advertiser may arrange for related interactive data to be associated or linked to her advertisement's content identifier. Or a movie studio can associate or link related interactive data to specific scenes or movie segments. The interactive data can then be used by a user to access interactive content prepared by advertisers and content creators.

After post-production and mastering, the content is preferably provided for distribution 18. The content is provided to TV networks 19, cable/satellite providers, etc. for further distribution. At this point, the content identifiers can be further associated with interactive data. For example, the content identifiers can be tailored (e.g., linked with specific interactive data) for local or regional programming.

The content is provided to service providers 20 (e.g., local cable operators, regional television stations, satellite distribution systems, etc). Preferably, the service providers 20 communicate with database 30. In this manner, a service provider may access linked information and facilitate customer feedback reporting. In one embodiment, the service providers 20 may also associate the content identifiers with interactive data, such as embedding a number that identifies the service provider, labeled distributor ID, into the content, e.g., via a digital watermark or VBI insertion.

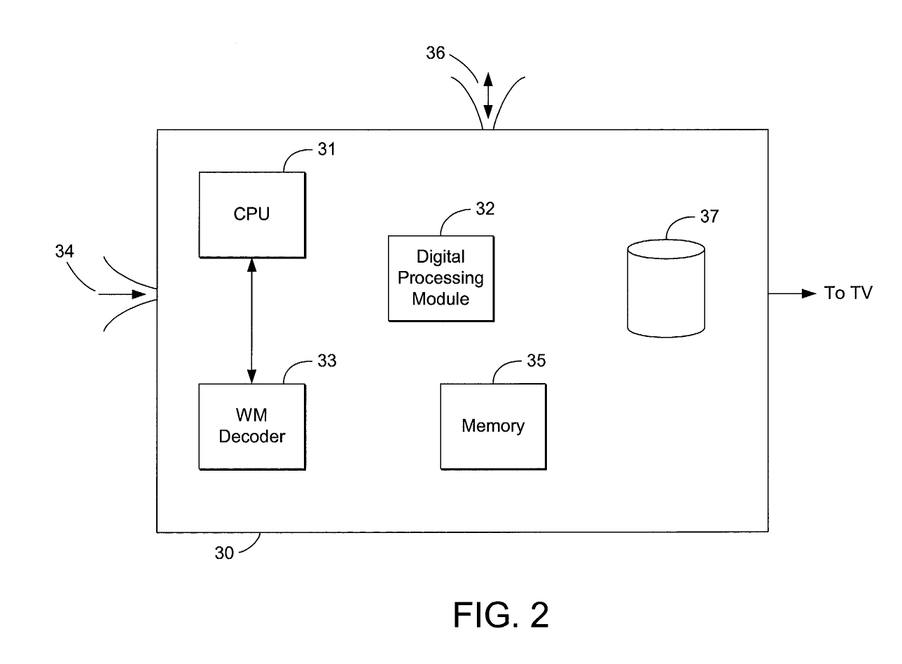

A consumer 25 receives content via a receiver 24. In this interactive system, the consumer selects content (e.g., a pizza commercial) to interact with. (A consumer may select content via a pointer, remote control, touch screen TV, web pad, graphical user interface, mouse, etc.). A corresponding unique identifier is detected via detector 22. In one embodiment, in which digital watermarks carry content identifiers, the detector detects a digital watermark and extracts the associated content identifiers. The consumer (or the consumer's receiver 24) uses the content identifier to query database 30. For example, the content identifier is passed to the database 30 to index corresponding interactive data. (In the present example, a URL is returned to the receiver and the consumer is linked to a corresponding pizza delivery service website. In another example, the interactive data includes interactive content, and such content is made available to the user.). Hence, the content identifier serves as a pointer to enhanced content. In one embodiment, receiver 24 includes a set-top box (“STB”). FIG. 2 illustrates various STB 30 components. STB 30 preferably includes an input 34 through which content is received. Input 34 may provide a content signal received from a cable system, a satellite feed, antenna, and/or etc. An electronic processing circuit (or CPU, circuitry, etc.) 31 is provided to help facilitate signal processing. For an analog signal, the input signal can be communicated to a television set. For digital signals, for example, an MPEG or MPEG2 signal, digital module 32 may be provided to help process such signals. STB 30 may also include a digital watermark decoder 33 (e.g., such as the detector 22 shown in FIG. 1). The watermark decoder 33 decodes watermarks, which may be embedded in the content. The STB 30 may optionally include a database 37 and a memory cache 35. Preferably, STB 30 includes a back channel 36. The back channel 36 is used to request and receive additional information, such as interactive content or data.

Content identifier(s) are stored in the STB 30 in one implementation (see below), for use at a later time, e.g., like a web browser bookmark. This enables the consumer to remember that he/she wants to learn more about that content or section of content, but does not require the consumer to interrupt the content at that moment.

Interactive Systems

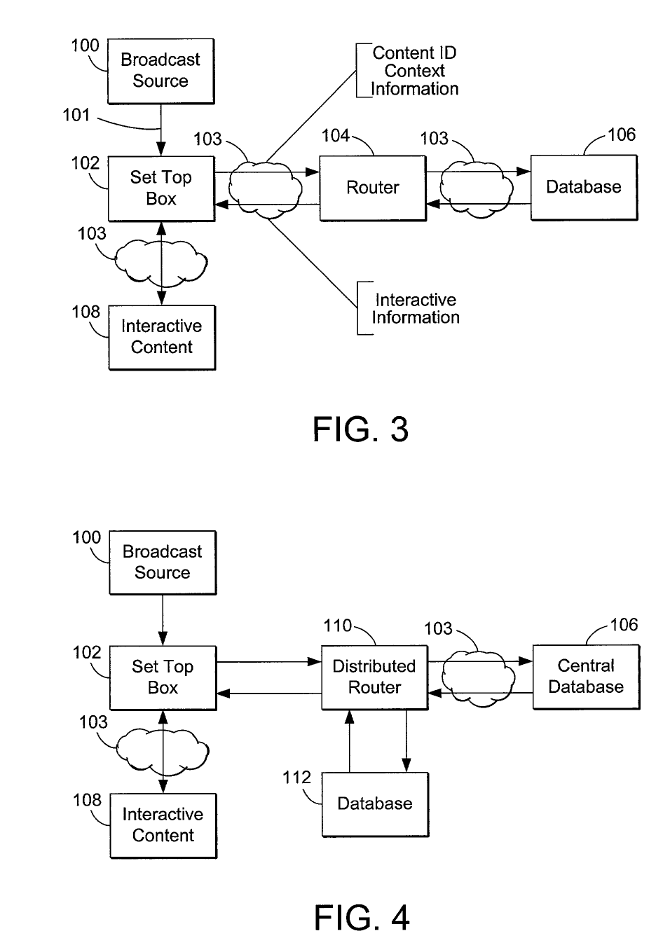

Specific interactive systems will now be described with respect to the figures, in which like components are represented with like reference numbers. As shown in FIG. 3, a broadcast source 100 provides content to a set-top box (“STB”) 102 via a forward channel 101. One broadcast source is a service provider 20 as shown in FIG. 1. As will be appreciated from the preceding discussion of FIG. 2, a STB is typically a consumer's device used for receiving broadcast video and/or audio signals via a forward channel, and for receiving interactive content via a back channel. Of course, instead of a set-top box, a computer having suitable input, output and processing components could be used. A forward channel 101 is used to delivers audio and/or video broadcast programming and advertising to a consumer's STB 102. A watermark detector residing in (or in communication with) STB 102 detects and decodes digital watermarks embedded within the content. Content identifiers are extracted from respective watermarks. (Alternatively, the watermark itself serves as a content identifier.). Using a back channel, the STB 102 communicates the content identifier to a router 104 via a network 103. (A back channel typically includes a channel used to send and/or receive requests for interactive data and content.).

In one embodiment, network 103 is the internet. Of course, the present invention is not so limited. The network 103 could include a dedicated network, an intranet, internet, wireless network, etc. Router 104 uses the content identifier to query a database 106. Like database 30 (FIG. 1), database 106 maintains interactive data, which is indexed via content identifiers. Database 106 may be local with respect to router 104, but is typically accessed via a network 103. Although reference number 103 is used throughout the figures to generically represent a network, it will be appreciated that the various illustrated networks may be the same (e.g., the internet) or may be different networks.

The STB 102 may optionally supply context information, such as a distributor identifier, programming identifier, content type, sequence identifier, and/or an advertiser identifier, along with the content identifier. Such context information may be used to further refine the search parameters or to identify a specific database to query, as discussed below.

Along these lines, if the content does not include an embedded time stamp, the STB 102 can track how long it has been since it has detected a specific ID and communicate that to the database. If the content was started at the beginning, this enables the database 106 to determine which section of the content the ID came from without requiring a different ID for each section. Alternatively, the content may have infrequent time stamps for absolute synchronization of the STB 102 such that if the STB 102 is tuned to the content in the middle of the content, it can align itself with the correct section once a time stamp is found, and the STB 102 can communicate to the database the precise time (such as in seconds) even though the time stamps are infrequent (such as once a minute).

Once identified, interactive data is supplied from the database 106 to the STB 102, via router 104. Generally, as discussed above, interactive data is used to link to interactive content associated with the broadcast content. For example, the interactive data may include a URL (or IP address) for the related interactive content. Using the interactive data, STB 102 accesses the corresponding interactive content 108, via network 103.

To illustrate, suppose a TV program includes a pizza commercial. The watermark detector extracts a corresponding watermark identifier (e.g., the content identifier), and the STB 102 forwards the identifier to router 104. Router 104 queries database 106 to find corresponding interactive data. In this example, the interactive data is a URL for the pizza shop's website. The URL is received by the STB 102, which opens a communications channel for the URL (e.g., launches a web browser or other interface to access the pizza shop's website via the received URL).

Distributed Router/Database

Typically, a STB (102) communicates with a router (104) and interactive content (108) via the STB's back channel. As discussed above, a back channel typically has a limited bandwidth, which may affect the quality of interaction. Furthermore, such a multi-stepped process (e.g., contact a router, query a database, return interactive data, open communication to interactive content, etc.) requires a finite amount of time, even with high-speed connections. Additionally, a problem exists in synchronizing the availability of interactive content to the presentation of the actual content.

Accordingly, to even further enhance consumer interactivity, a distributed router interactive system is provided.

A distributed router interactive system is illustrated with respect to FIG. 4. A broadcast source 100 supplies content to a STB 102. A watermark detector residing in (or in communication with) STB 102 detects and decodes watermarks associated with the content. Content identifies are extracted from respective watermarks. STB 102 then communicates with a distributed router 110. A distributed router is defined broadly herein to include a device or process, which manages some or all of an interactive data database. For example, the distributed router 110 may be provided by the broadcast source (e.g., a cable operator) 100. Alternatively, STB 102 communicates with the distributed router via a network. The distributed router 110 maintains or has direct access to database 112. Database 112 maintains a mapping of some (e.g., a subset) or all (e.g., the entire set) of content identifiers to interactive data mappings. When a set of the content identifiers is included the system is an efficient version of a mirrored system. Response time is greatly reduced with such a distributed router system since the IDs and database for broadcast content can exist locally, such as in the cable head-end or in the STB. Hence, the quality of interaction is increased.

In an embodiment in which database 112 maintains a subset of mappings, the subset can be selected based on a variety of criteria, including local advertisements, geographic preferences, selection history, viewer preferences, upcoming identifiers, frequently or recently accessed identifiers, etc. If the distributed router 110 is unable to find corresponding interactive data for a particular content identifier, the router 110 may optionally query a central database 106 via a network 103. Preferably, database 106 maintains a repository of all possible content identifiers and corresponding interactive data.

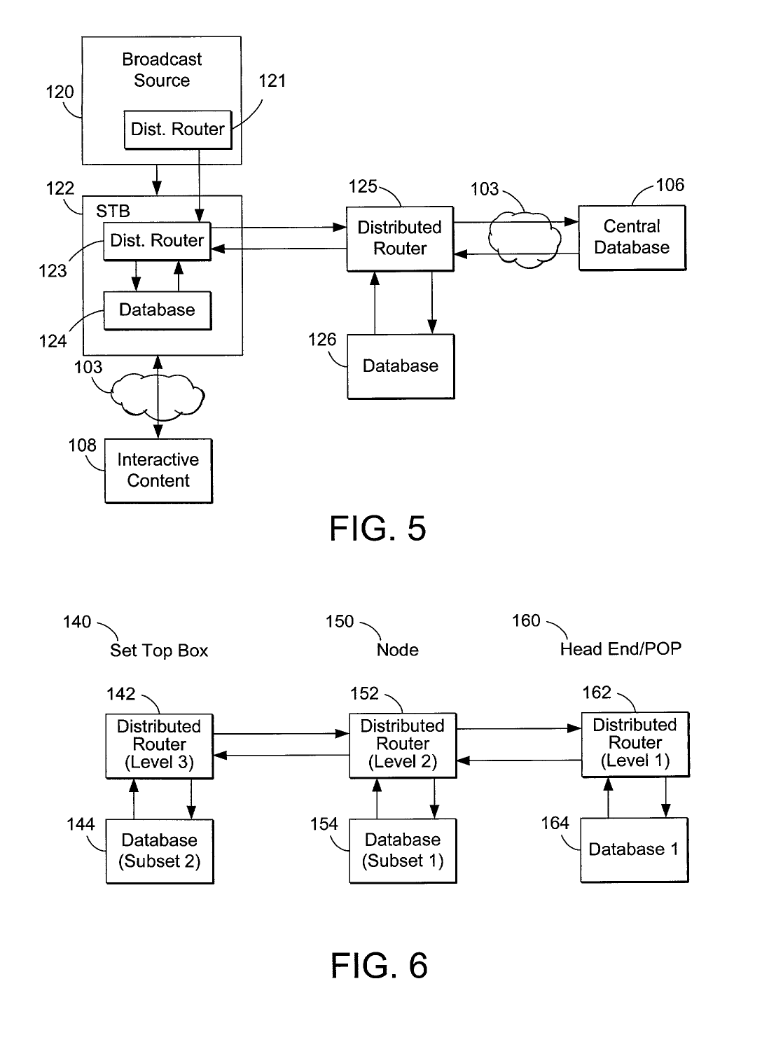

Extensions of the distributed router system (FIG. 4) are further explained with reference to FIGS. 5-8. In FIG. 5, a broadcast source 120 provides content to a set-top box (“STB”) 122. A watermark detector residing in (or in communication with) STB 122 detects and decodes digital watermarks associated with the content. Content identifiers are extracted from respective digital watermarks. The STB 122 preferably includes a distributed router 123 and corresponding interactive data database 124. Database 124 maintains a subset of interactive data. Preferably, STB 122 initially queries distributed router 123 (and database 124) for interactive data corresponding to a decoded watermark identifier. The distributed router 123 returns corresponding interactive data if present in database 124. In the event that a particular content identifier is not present in the database 124, the router 123 (or alternatively, the STB 122) queries a higher-level distributed router. The term “higher level” in this context implies a larger subset of interactive data. As illustrated in FIG. 5, STB 122 (or router 123) communicates with a distributed router 125. Distributed router 125 communicates with an interactive data database 126. Preferably, database 126 maintains a larger subset of data than does database 124, increasing the chances of a content identifier match. Distributed router 125 also communicates with a central database 106 via a network 103. Central database 106 preferably includes a listing of all possible content identifiers and linked interactive data. For a subject content item and/or advertisement. Under the FIG. 5 system, a local database is consulted, prior to accessing higher-level databases. Access time is reduced and efficiency is increased with such a system.

The databases may be populated or updated each time a new query is requested. Alternatively, the databases may be updated based on up coming programming and/or advertising, or based on past preferences. Of course, the databases may be updated using alternative methods as well.

Optionally, with further reference to FIG. 5, the broadcast source 120 may include a distributed router 121. The distributed router 121 may provided additional upcoming content identifiers within communicated content, such as using VBI lines in an analog system or a MPEG private data channel in a digital system to update router 123 and database 124.

FIG. 6 illustrates another perspective of the distributed router relationship. A set-top box 140, node 150, and head-end and/or point of presence (POP) 160 each include a distributed router and corresponding database. POP 160 includes a router 162 to manage a set of interactive data (e.g., database 164). Node 150 includes a distributed router 152 to manage a subset of interactive data (e.g., database 154). Finally, STB 140 includes a distributed router to manage a subset of interactive data (e.g., database 144). The size of the respective database decreases as the respective levels increase. For example, a data set residing on database 144 (e.g., subset 2) is typically smaller than a data set residing on database 154 (e.g., subset 1). A higher-level database is queried when a lower level database does not maintain the requested data. Accordingly, response time decreases since interactive data lookup occurs closer to the requesting STB 140.

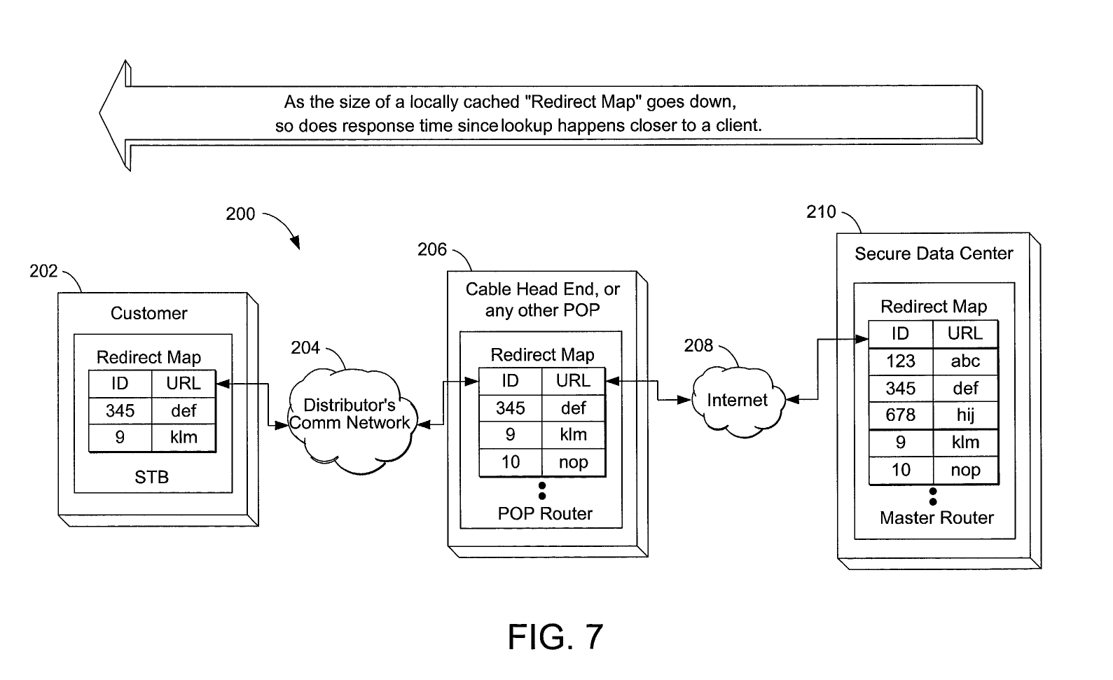

FIG. 7 shows an example of a distributed router system 200. A customer (e.g., a television customer) includes a redirect map. In this embodiment, a redirect map includes a mapping of content (or watermark) identifiers to URLs. A redirect map, however, is not so limited. Instead of mapping content identifiers to URLs, the identifiers can be mapped to other interactive data including IP addresses, storage locations, interactive channels, content, etc. The customer's STB 202 preferably maintains a subset of a master redirect map. The STB 202 may use a heuristic to reduce the size of its locally cached redirect map, such as frequency of use, last request, most recent request, upcoming programming, etc. STB 202 communicates with a cable head end (or other point-of-presence, or POP) 206 via a distributor's community network 204. The POP router 206 builds and caches a local redirect map for all requests that have been processed in a time period (e.g., day, hour, 15-minute period, etc.). Preferably, a new content identifier request forces the POP router to either add a corresponding entry to its table or to synchronize with the next node up in the hierarchy. Eventually, the POP's redirect map stabilizes. The map can then be periodically refreshed to avoid becoming stale.

Returning to network 204, after a watermark payload (e.g., including a content identifier) is decoded for a first time, a new redirect map (or a map entry corresponding to the watermark identifier) is put on the network's carousel for access by all STBs in the network. Local STBs (e.g., STB 202) can be updated or refreshed accordingly.

POP router 206 queries or hits the next node up in the established router hierarchy when POP router 206 receives a request for an identifier not present in its map. For example, POP 206 hits secure data center 210 for any unseen requests. Secure data center, in this example, includes a master redirect map.

Of course, additional nodes can be added to the system shown in FIG. 7. Also, the redirect map may be updated periodically, based on up-coming programming, and/or based on user preferences, etc. Such modifications are within the scope of the present invention.

As an example, consider if content from a creator Y is flowing through network X, and X decides to offer a URL as well. The URL will then be listed in the master Router. If X does this for enough content, then their POP router can build a Redirect Table by querying the master table for all content that will have a URL provided by X. This allows the POP Router to build the table up front, saving timely costly queries to surrounding routers for a watermark identifier the Router has not previously seen.

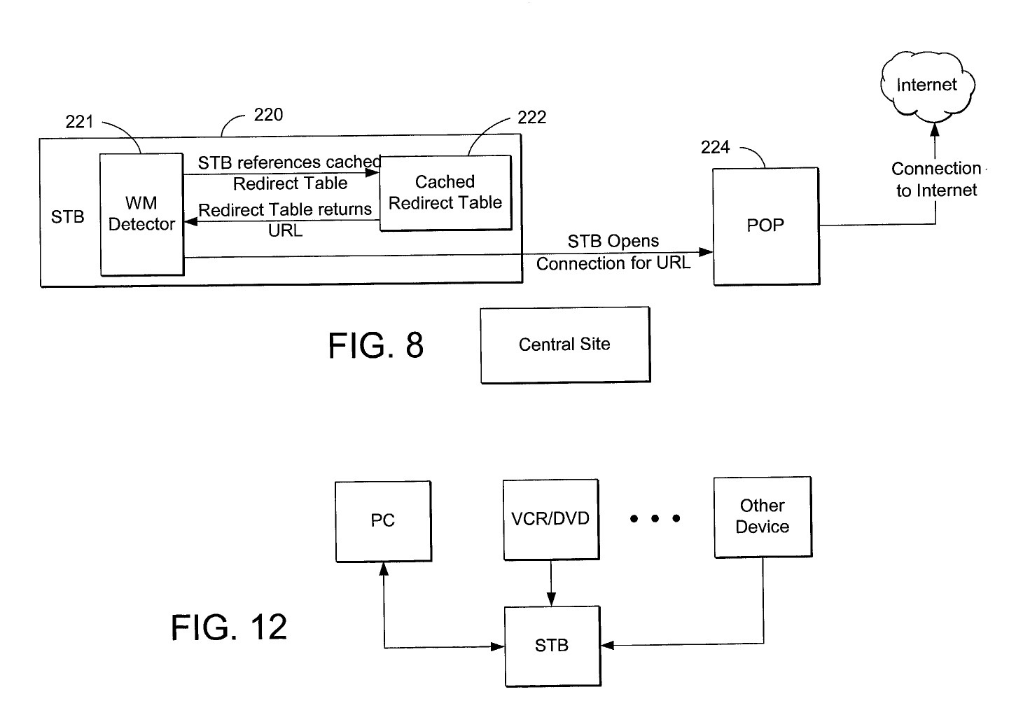

In still another prospective, as illustrated in FIG. 8, a STB includes a cached redirect table (or map) 222. The table is of sufficient size to accommodate potential (and future) requested content identifiers. A watermark detector 221 detects and decodes a content identifier from a digital watermark embedded within the content. The identifier is supplied to the cached redirect table 222 to index corresponding interactive data (e.g., a URL). The interactive data is returned, and the STB opens a connection for the URL. The URL request is directed to the internet via a POP 224. In this system, a central database 226 need not be queried for interactive data.

Data Push System

System efficiency is increased when interactive data access time is decreased. One system (and method) achieves increased efficiency by pushing data in anticipation of a future request. For example, content identifiers for upcoming content can be pre-identified, e.g., from an electronic program guide (EPG) or other advanced planned system. Corresponding interactive data (e.g., URLs, IP addresses, storage locations, communication channels or ports, etc.) is identified from a redirection map or database. Such corresponding interactive data can then be pushed to a set-top box (STB) before the content having those particular identifiers is broadcast to the STB. Preferably, the corresponding interactive data is pushed down via the forward channel, thus freeing bandwidth on the back channel. Moreover, pushing interactive data ahead of the corresponding content drastically reduces access time and synchronizes content, particularly when the interactive data is cached locally on a STB. This method is preferably used in distributed systems where a distributed router and database exist on a consumer device, such as a STB, as discussed above.

Consider an EPG example where the programs are stored along with the content IDs. This enables the EPG to push the interactive data (or triggers) to the STB. It also enables the system to verify that the EPG is correct, and update the EPG, if required. For example, if the STB includes an EPG which expects “Gilligan's Island” episode 29 (content ID 20019) at 9 PM on channel 12, but instead at 9 PM on channel 12, content ID 20091 is included in a corresponding digital watermark, the STB can communicate with a head-end and report the problem. The head-end can also find out what program corresponds with ID 20091 and update the local EPGs. Similarly, the head-end could detect the digital watermark and check the IDs against the EPG directly, and update the EPGs if required.

In another implementation, a head-end or POP anticipates upcoming interactive data and pushes this data to lower level nodes/routers. Data can be anticipated by analyzing upcoming content (and associated content identifiers), consulting programming guides, predicting based on viewing trends, past usage, etc.

However, along with the interactive data (for example, the IDs and related URLs), the interactive content (for example, the initial web page the URL links to) could be pushed to the consumer devices, such as a STB 230. Specifically, a head-end node could include a watermark detector. The head-end node then becomes a content identifier filter. As such, the head-end pushes related interactive data in accordance with currently (or future) broadcast content. The interactive data is preferably cached locally in STBs or in nearby distributed routers for use when requested.

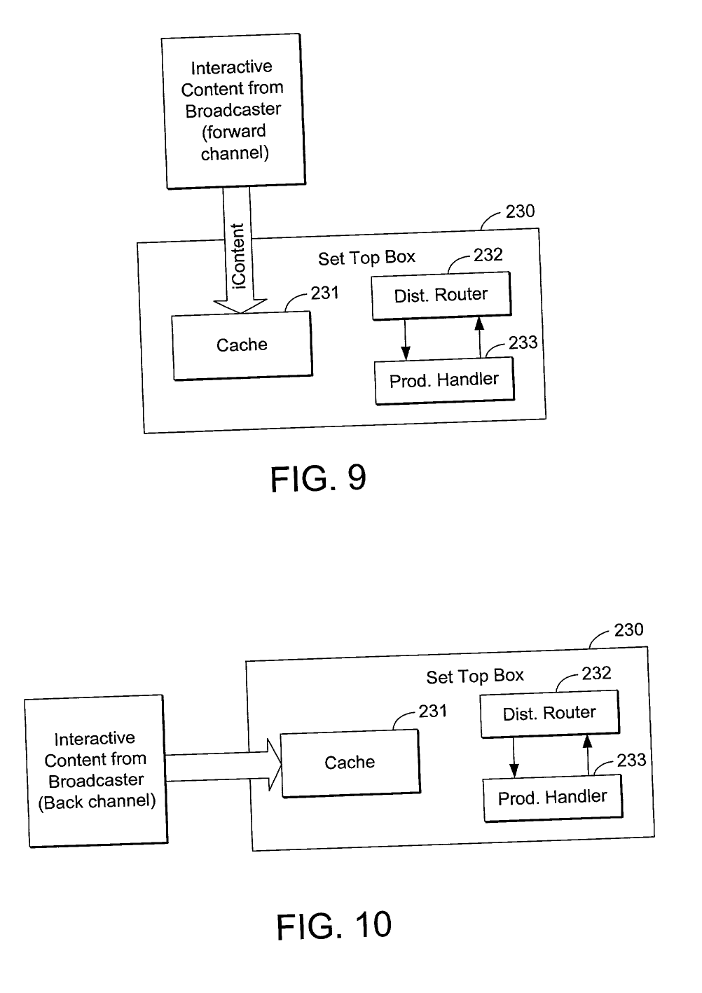

In still another variation, a first set-top box in a system reads a content identifier (such as included in a digital watermark). The extracted content identifier is returned from the first set-top box to a distributed router via a back channel. The distributed router multicasts corresponding interactive data to all STBs (or a set of STBs) in the system. More specifically, interactive content (e.g., HTML pages, related text, graphics, JAVA applets, etc.) is pushed (or broadcast) with the corresponding content itself. For example, as shown in FIG. 9, interactive content is pushed via the forward channel, along with (or in advance of) the content itself. The interactive content is preferably cached in cache 231 for future or concurrent use. The interactive content can be accessed and managed directly or via a distributed router 232 and product handler (e.g., database, map, table, address locator, etc.) 233, as discussed in the embodiments above.

With reference to FIG. 10, a broadcaster can also push interactive content (or interactive data) in advance of (or concurrently with) content via a back channel. The content is cached in cache 231. Of course, the cached interactive content may be accessed directly or via the distributed router, etc.

To prevent unintended exposure to unwanted material, or to impose self-regulation, the interactive content can be rated using rating bits (e.g., a certain bit(s) in a watermark payload). Such rating provides protection and self-regulation. Alternatively, the content identifiers can include rating-bits. The local STB may be programmed to block (e.g., prohibit or filter) requests for interactive data (and/or content), with unacceptable ratings.

Context Information

To provide further filtering and mapping capabilities, context information may be supplied in addition to the content identifiers. Context information is then used to help map the content identifiers to interactive data. To illustrate, key words (e.g., from closed captioning, or from an audio segment) are forwarded to a database, along with a content identifier. Together, the key words and content identifiers are used to index into the database, which help identify related interactive data (e.g., a URL, web page, IP address, etc.). The content identifier is a rough index that narrows the inquiry, while the key words are used as finer indexes to improve the look-up process.

Additional context information may include distributor identifiers, producer or advertiser information, etc. Including context information provides a finer level of gradation for identifying interactive data. Of course, context information may be included to enhance the database look-up of the systems described above.

As a further enhancement, a time code (and/or video frame number) may be supplied along with a content identifier to improve resolution of the database look-up. An example of where the time stamp is provided by a digital watermark and/or STB is described above. In another embodiment, a SMPTE time code may be included with a content identifier to help refine a database look-up.

Central Accounting

To provide for payment and/or usage information in a push system, a STB may be configured to return usage information to a central site. For example, interactive content may be pushed down to a STB, and the STB records when such content is displayed and/or accessed. Such a record can be supplied to the central site for accounting to facilitate payment or other usage (information gathering, Neilson ratings, statistics).

Additional System Details

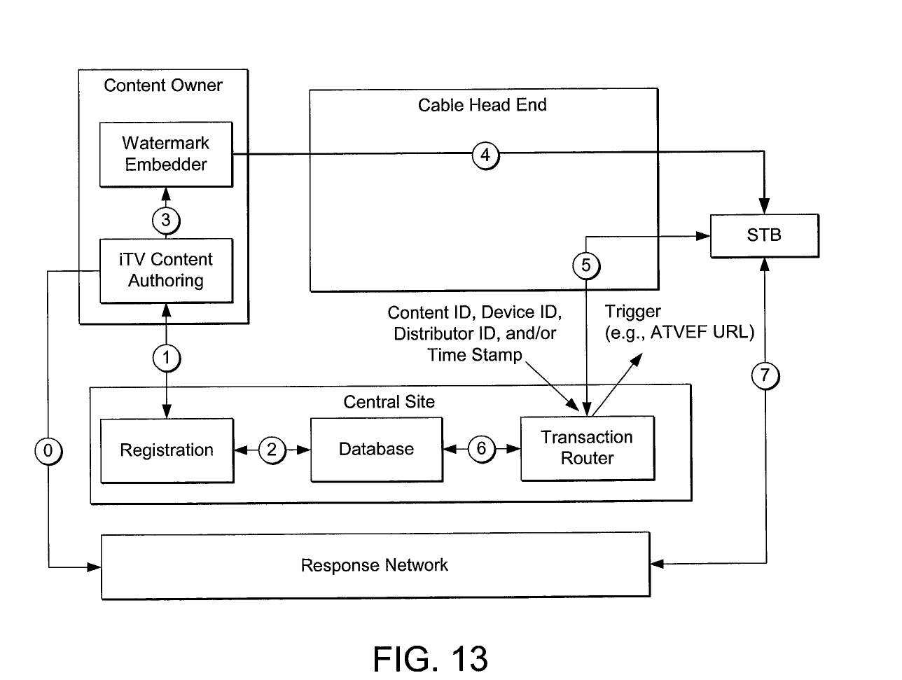

FIG. 13 is a functional block diagram showing high-level data flow for an overall method in one embodiment of an interactive television system. Content (e.g., interactive content, audio/video content, etc.) is authored and/or registered in step 1. The registration process may include a step of contacting (or communicating with) a central site to associate content identifiers with various content items (or subsets of a content item). Corresponding data records are established in the database (step 2). This database management process may include the steps of associating interactive content with the unique identifiers, creating data fields, cataloging the identifiers, receiving additional content to be linked to the identifiers, etc. Digital watermarks are embedded within the content in step 3. As discussed, the watermarks carry (or include) the unique content identifiers. In step 4, the watermarked content is distributed, e.g., via a cable head end and associated network, to a user device (e.g., a STB or other computing device). The user device detects and decodes the digital watermarks to retrieve the embedded content identifiers. The STB communicates the content identifiers to a transaction router (step 5). The transaction router may be associated with the central database (central site), or may be a distributed router. The transaction router interrogates the central database for interactive data associated with particular content identifiers (step 6). The interactive data is then provided to the STB, e.g., via the transaction router. In one implementation, the STB extracts (or generates itself) additional information, such as a device identifier (e.g., identifying the type of set-top box, receiver, watermark detector, and/or computing structure), distributor identifier, time stamp data (e.g., time location in a content item, production time stamp, advertisement insertion, running time from a starting point, etc.), and/or etc. (The interactive content authors/owners may also optionally communicate with the response network, e.g., to post interactive content, update web pages, etc., as shown in step 0.).

The STB may then request interactive content (e.g., web pages, video, audio, text, etc.) associated with the interactive data (e.g., IP address, pointer, URLs, etc.) via a response network, as shown by step 7. The response network is preferably the internet, but the present invention is not so limited. Of course, the response network may include a dedicated network, wireless network, a community network, an extranet or intranet, a network associated with the cable head end, etc.

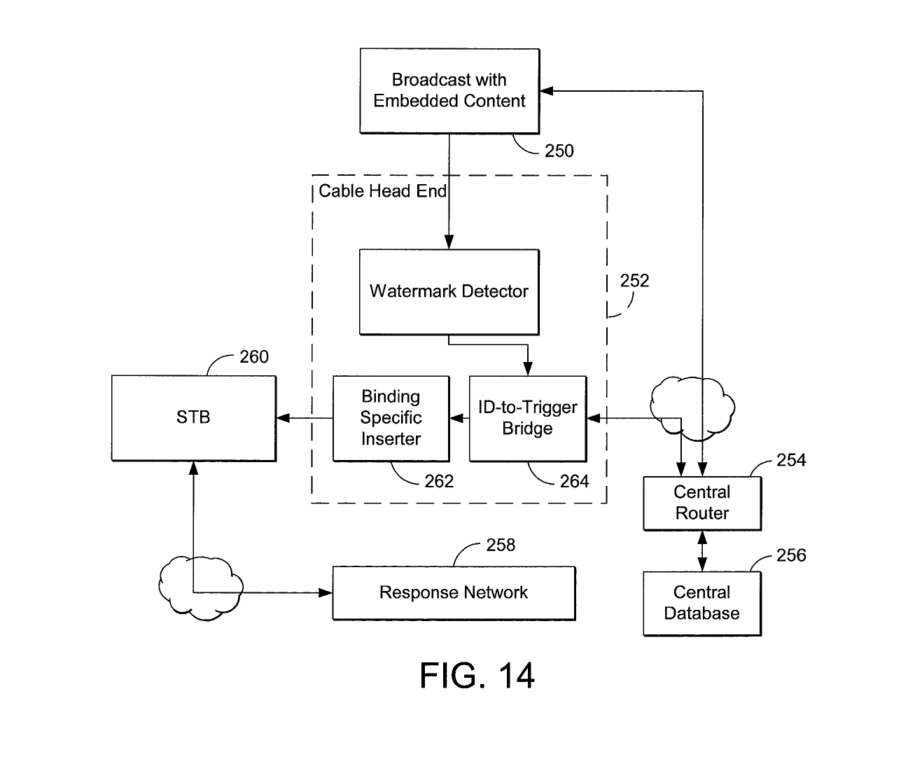

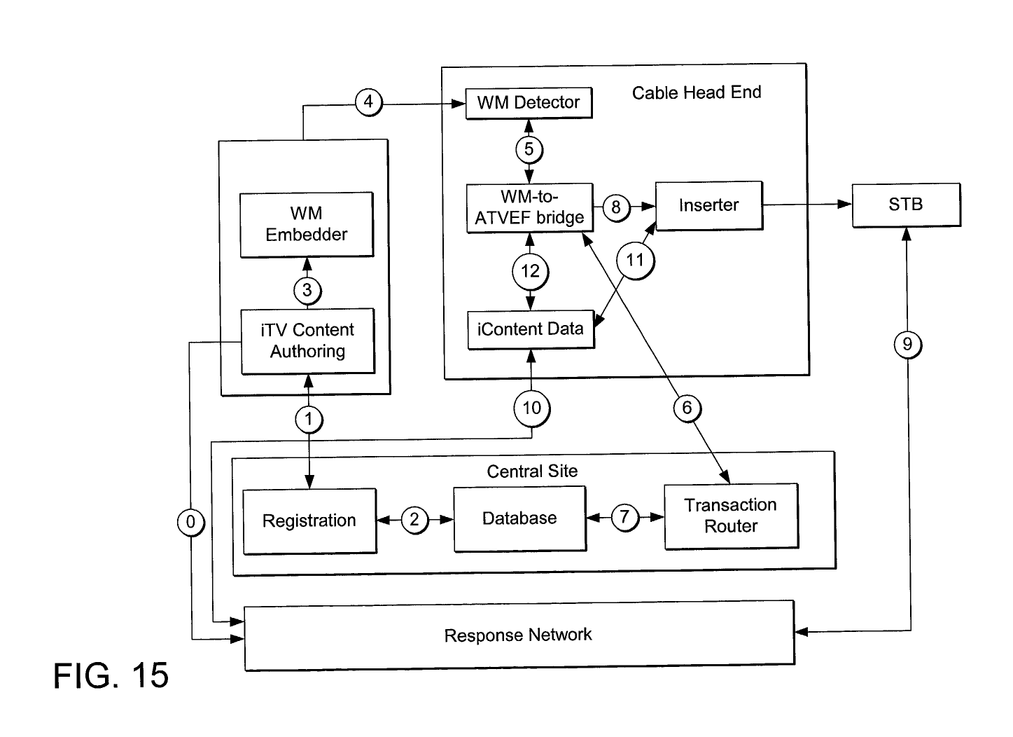

FIG. 14 is a functional block diagram, which illustrates yet another interactive television system according to the present invention. The illustrated system combines watermarking technology with existing, binding specific inserters (e.g., VBI). In a modified implementation, this system is retrofitted according to current infrastructure, which includes ATVEF compliant VBI detectors in STBs. It is also advantageous in the near term, because digital watermark detectors can then be placed at the head-ends and not within each STB. Embedded content is broadcast 250 as discussed above. A cable head end 252 receives the broadcasted, embedded content. A watermark detector 266 detects and decodes the embedded content (e.g., to extract a unique content identifier). (In one embodiment, a known embedding and detecting product such as WaterCast™, by Philips, is employed. Of course, there are many other embedding and detecting products and techniques, and such are suitably interchangeable with the present invention.). The extracted identifiers are communicated from an ID-to-Trigger Bridge (e.g., a router with data management functionality, communications module, a database with communications capability, etc.) to a central database 256 (e.g., via a central router 254). As described in FIGS. 4 through 7, a distributed, rather than a central architecture, can be alternatively used. In this case, the distributed system need not extend to the STB because ATVEF standards are used between the head-end and STB.

A corresponding trigger (e.g., a URL, IP address, data structure, pointer, etc.) is communicated to the ID-to-Trigger bridge 264. The triggers are associated or inserted with the broadcasted content by the binding specific inserter 262. In one embodiment, the triggers are inserted via VBI. In another embodiment, triggers are inserted by a digital multiplexer. Of course, other known mixing, multiplexing, and signal insertion techniques may be suitably and interchangeably used with the present invention. A STB 260 receives content, including the inserted triggers, from the cable head end 252. The triggers are then extracted and used to retrieve related information via a response network 258. As a result, the STB need not query the central database, freeing up valuable back-channel bandwidth and increasing overall response efficiency.

The FIG. 14 system has many additional advantages, including broadcast monitoring. For example, transitory content (e.g., infomercials, commercials, news shows, etc.) may be embedded with data (e.g., identifiers). The identifiers are used to identify related triggers. Once embedded in content, a trigger can be used by a STB to access additional data. In one example, a STB automatically communicates with a web site corresponding to a trigger (e.g., a URL). The web site records the date and time of the communication, and uses such information to monitor the broadcasting of commercials. In still another embodiment, the trigger itself is recorded by a STB to facilitate monitoring or reporting. In another embodiment, user input is required to activate a trigger, and contact a web site. Once contacted, data is recorded and used for monitoring purposes. Of course, the FIG. 14 system is not limited to content monitoring of transitory content, but also is used to facilitate interactive television for all types of content.

The FIG. 14 embodiment also allows implementation of a watermark-enabled interactive television system without upgrading or replacing existing STBs with watermark detectors, since a cable head end performs watermark detection.

It is implicit in FIG. 14 that one content ID can create different interactive effects in each different head-end system by the ID-to-Trigger Bridge 264 embedding the correct trigger for that head-end system. This process is much simpler than ATVEF, where the content needs the correct trigger for that head-end system at the time of creation. In addition, with ATVEF, if different head-end systems have different triggers, different content has to be created and distributed for each head end system. It is likely that different head-ends require different actions due to carriage agreements. For example, AOL Time Warner cable may take an AOL Time Warner movie to an internal walled-garden whereas AT&T cable may take an AOL Time Warner movie to an AT&T branded version of that walled-garden.

FIG. 15 illustrates another perspective with respect to the FIG. 14 embodiment. (In FIG. 15, steps 0-3 are the same as those discussed with respect to FIG. 13.). In particular, the watermark detector communicates unique identifiers to the watermark-to-trigger bridge, as shown in step 5. In step 6, the watermark-to-trigger bridge can then communicate with the transaction router to retrieve related trigger information (e.g., a URL, IP address, pointer, etc.) from the database (step 7). The triggers are inserted into the content as discussed above (step 8). The STB extracts the triggers and can then communicate with the response network to gather the related interactive content (step 9). The interactive content can be returned to the STB via the response network. As a variation, the interactive data (and even interactive content in some cases) can be communicated to the cable head end (step 10). In this case, the interactive content and/or related data (including URLs, IP addresses, web pages, video, audio, etc.) can be inserted with content for delivery to the STB (step 11). In this alternative embodiment, pushing data to the STB via a forward (e.g., cable head end) channel frees up back-channel usage, and even further increases interactivity by improving overall response time.

The FIG. 14 system (and/or other interactive systems) may also be modified to include a regional watermark detector in the cable head end. Such a detector is responsive to variations in the broadcast regions (e.g., time zones). The detector will extract corresponding regional information from the watermark, which is used to index the central database. Alternatively, the watermark detector appends information (e.g., a region identifier or extra regional bit) to the extracted data, which data is then used to retrieve appropriate region information.

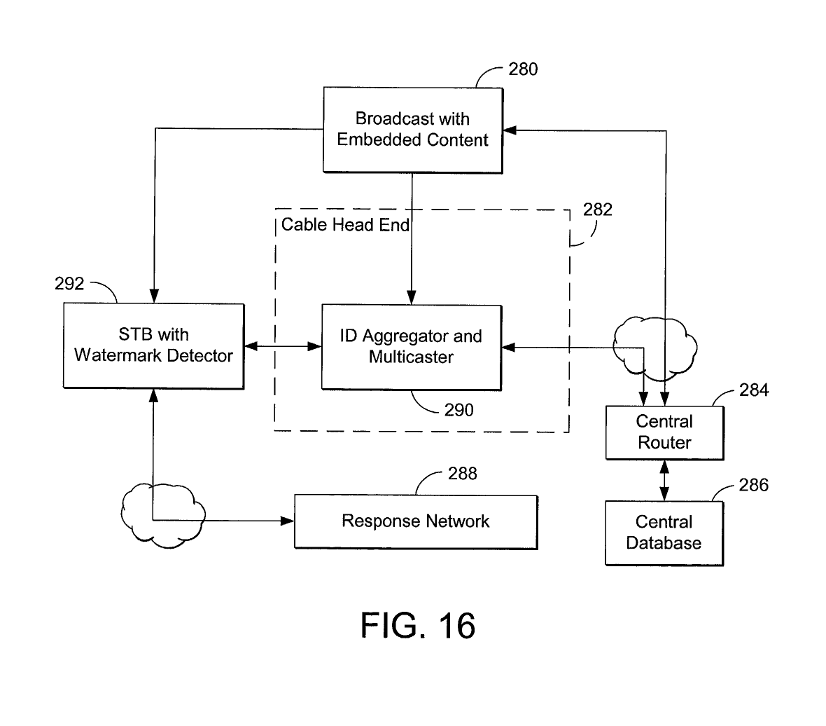

Another embodiment of an interactive television system is discussed with respect to FIG. 16. FIG. 16 is similar to FIGS. 3 through 5, where FIG. 16 includes a response network and specific head-end method for distributing (i.e. pushing) interactive data to the STB. The FIG. 16 system broadcasts 280 embedded content as discussed above. The embedded content is distributed via a cable head end (or other router) 282 to a STB 292. (Typically, there will be a plurality of STBs associated with each cable head end. Only one STB is illustrated in FIG. 16 to help with the clarity of this discussion.). The STB 292 preferably includes a watermark detector and a data cache. Upon receipt of watermarked content, the STB 292 detects and decodes a watermark to obtain a unique identifier. (As discussed above with respect to other embodiments, the unique identifier can be used to interrogate a database for related interactive data.).

The unique identifier is relayed from the STB 292 to the cable head end 282. Preferably, the cable head end 282 includes an ID aggregator 290. The ID aggregator 290 manages requests sent from associated STBs. (Optionally, the ID aggregator 290 sends an acknowledgement acknowledging a request sent by a STB. Upon receipt of an acknowledgement, the STB monitors (or listens) for multicast messages from the ID aggregator 290.). The ID aggregator 290 sends the unique identifier to a central database 286, via at least router 284. The unique identifier is used to index related interactive data (or triggers), such as URLs, IP addresses, pointers, etc., which are communicated to the cable head end 282. The cable head end 282 caches the interactive data, and communicates the interactive data to the STB 292. (The ID aggregator may optionally multicast the related interactive data to all, or a sub-set of, the STBs in head end system. Such related interactive data may be cached locally in the respective STBs for immediate or future use. In such a case, the ID aggregator need not cache the data.).

The ID aggregator 290 functions as a filter by only sending a new request to the central database. Also, it is likely that the ID aggregator 290 will receive many requests concurrently (or with a given window). The ID aggregator 290 will typically only send one request to the central database, which significantly reduces traffic to (and in) the database 286. In one embodiment, the ID aggregator 290 maintains a data structure or database of previously requested identifiers and related interactive data. In another embodiment, the ID aggregator 290 maintains only a listing of previously requested identifiers, since all new related interactive data is multicast to each STB in the head end system. In another embodiment, the ID aggregator has the ability to forward-look, or preview upcoming content (e.g., content for the next 1-3 hours). The ID aggregator, when equipped with a watermark detector, may extract identifiers in advance and then retrieve related interactive data. (Alternatively, the head end receives a database refresh, including a listing of upcoming identifiers and related interactive data.). This advance-interactive data may be cached in the cable head end, or multicast to the STBs. The advance-interactive data may be relayed to the STBs to reduce request time, and reduce traffic to the central database.

Upon receipt of interactive data, the STB 292 may retrieve interactive content from the Response Network 288.

Identifiers

The following discussion further illustrates various identifiers. It should be appreciated that these inventive identifiers and formats can be interchangeably used with the embodiment disclosed above. However the present invention is not so limited. From the perspective of a cable head end (e.g., see FIG. 14), an identifier (first column in Table 1) is used to access a link (second column in Table 2). A digital watermark may include (or serve as) an identifier, which is used to access a link (e.g., second row of Table 1). In one embodiment, a digital watermark preferably includes a content identifier. The content identifier is used to index or interrogate a database to identify an associated link, such as a cache trigger, as shown in the third row (second column). (Of course, the cache trigger may include a URL, IP address, memory pointer, link, etc.).

TABLE 1

| Identifier | Link |
|---|---|
| Digital Watermark | Link |
| Content Identifier | Cache Trigger |

From the perspective of a set-top box (STB), as shown in Table 2 below, an identifier (first column in Table 2) is communicated from a STB to a database to retrieve an associated link (second column). The identifier may be provided by a digital watermark, and may optionally include a detector identifier. A detector identifier is preferably not carried by a digital watermark, and is rather provided by the STB. The detector identifier is preferably used to identify particular data formats, specific types of content, receive targeted promotionals, etc. The detector identifier may include information such as the detector and manufacture data. The content identifier and the manufacture identifier may be used to gather related interaction data/content, send appropriate device specific content, or etc. Such a Table 2 data structure may also be stored locally on a STB. For example, links (e.g., triggers, URLs, IP addresses, etc.) may be cached locally according to content identifiers, and optionally, further categorized via manufacture identifiers.

TABLE 2

| Identifier | | Link |
|---|---|---|
| Digital Watermark | Detector | ″ |
| Content ID | Manufacturer ID | |

From the perspective of a central database (or distributed or local database), Table 3 further illustrates a relationship between identifiers and associated links. In Table 3, the identifiers are divided into watermark and non-watermark identifiers. A watermark payload or message preferably includes content identifiers and time identifiers. The content identifier uniquely identifies content (or subsets of content, types of content, etc.). In one embodiment, the content identifiers can be divided into content owner identifiers and content identifiers. The content owner identifiers can be used to link to a database owned or maintained by the content owner (e.g., via a central database). Or the content owner identifiers may be used to further refine a database inquiry, or to search a separate data record or database maintained by a central database.

TABLE 3

| Identifier | | | | | Link |
|---|---|---|---|---|---|
| Digital Watermark | | | Non-Digital Watermark | | ″ |
| Content ID | | Time ID | Detector ID | | ″ |
| Content ID | | Time ID | Distributor ID | Manufacturer ID | ″ |
| Content | Content | Time ID | Distributor ID | Manufacturer ID | ″ |
| Owner | ID | | | | |
| ID | | | | | |

The time identifier can be used to even further refine a database look-up. For example, a content identifier is used as a first cut in a database search (e.g., identifies a possible set of related interactive data or data link). The time identifier is used to further refine the search (e.g., identifies a subset of related interactive data according to the specific time). A time identifier may be embedded throughout a video/audio signal or may be supplied by a STB. The time identifiers preferably reflect the timing (or a particular segment, time interval, etc.) of a program.

Alternatively, as shown in Table 3A, a time stamp can be provided by a STB. As discussed above the time stamp can be obtained from SMPTE time codes in digital broadcasts, VBI in analog broadcasts, or created from a timing chip in the STB, which can be enhanced by including an absolute but coarse time stamp in the digital watermark.

TABLE 3A

| Identifier | | | | | Link |
|---|---|---|---|---|---|
| Digital Watermark | | Non-Digital Watermark | | | ″ |
| Content ID | | Detector ID | | | ″ |
| Content Owner | Content ID | Time | Distributor | Manufacturer | ″ |
| ID | | ID | ID | ID | |

Consider the following example with reference to Table 4. A unique content identifier (e.g., “Content ID” in Table 4) is associated with a 40 second advertisement. A time identifier is used to segment or further identify portions of the advertisement. In this example, the advertisement is segmented into eight (8) five-second intervals. A unique time identifier is associated with each time interval (e.g., 000 is associated with the first 5 second, 001 is associated with an interval between 5 and 10 seconds, and so on). A watermark detector extracts data relating to both the content identifier and the time identifier. The database then uses the content identifier as an index to isolate a set of possible interactive data. The time identifier is used as an index to narrow down the isolated set to the specific, related time segment. (Of course, the time segments need not be defined in 5-second intervals. Instead, the intervals may be longer (e.g. 10, 25, 30, etc. seconds) or shorter (e.g., 1, 2, 3.5, etc. seconds). Also, the time identifiers may include additional bits to accommodate long-playing content.).

TABLE 4
Content ID

| | | | | | |
|---|---|---|---|---|---|
| 000 | 001 | 010 | 011 | . . . | 111 |
| 5 sec. | 10 sec. | 15 sec. | 20 sec. | . . . | 40 sec. |

Returning to Tables 3 and 3A, non-digital watermark identifiers may also be used to access and/or categorize related interactive data. To illustrate, a detector identifier may be supplied by the STB to further define a look-up request, specify preferred or required data formats, and etc. The detector identifier may be divided into distributor identifiers and manufacture identifiers. Each of these identifiers may be used, respectively, to identify the distributor of the STB (or components within the STB) and the manufacture of the STB. Specific data formats, data requirements, promotionals, etc. may be linked with such identifiers. (For example, a device identifier may be used to ensure that interactive data point to a source, which has a proper format or interface, according to the device requirements.).

Advance Data Caching

In one embodiment, a cable head end receives a subset of information in advance of regular programming. The advance-information may include content, identifiers and related interactive data (or a combination or subset of such). For example, the cable head end may receive, in advance of scheduled programming, 3-days worth of upcoming unique identifiers. The cable head end may then query the central database and retrieve corresponding interactive data, which is then associated with the unique identifiers. (Alternatively, the cable head end receives both the identifiers and the related interactive data.). The identifiers and related data are cached for upcoming use. Such advance previewing or caching significantly decreases response time to STB requests.

In another embodiment, a STB receives and caches a subset of upcoming information. Such information may include upcoming content, upcoming identifiers and/or related interactive content or data. In the event that the STB receives upcoming content, a decoder can process and extract unique identifiers. The STB may request related interactive data and/or content for future use. Alternatively, the STB may receive a set of upcoming unique identifiers (and/or interactive data). The STB may then cache the unique identifiers, and associated interactive data, for future use. For example, the STB may receive 1-3 hours worth of upcoming identifiers. The STB may then request associated interactive data, which is stored according locally at the STB according to the unique identifiers. Then, when a user selects a content item (or an object within a content item) for interaction, the watermark decoder detects and decodes the associated watermark to extract the corresponding unique identifier. The unique identifier is then compared against the STB's local database. The corresponding identifier is found and the related interactive data is used to request data via a response network. In still another embodiment, the STB locally stores upcoming interactive content locally, to even further enhance response time.

Context Information and Binary Identifiers

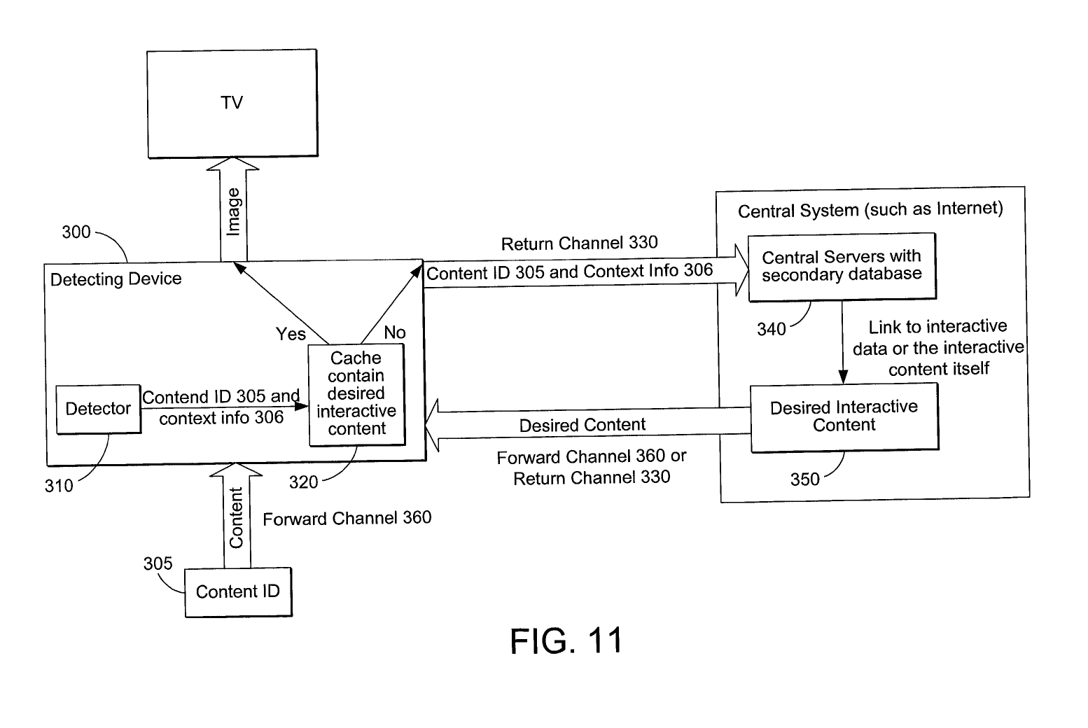

As discussed, a content identifier can be used to greatly enhance an interactive television system. In one embodiment, as shown in FIG. 11, context information 306 is optionally used to identify a distribution system, possibly only containing a distributor identifier (e.g., “ID”). The context information 306 can include additional information, such as time, date, and/or zip code, which is added by detector 310 and may have been entered by the user or system administrator during setup. The user may provide private information, and could receive special benefits for allowing such information to be transmitted as part of context info 306, for example, as discussed in assignee's U.S. patent application Ser. No. 10/017,679, filed Dec. 13, 2001, which is herein incorporated by reference. The context information 306 may include a detector or consumer ID, which is used to link to another central database containing data on the consumer, such as age, sex, zip code and so on. The detector or consumer ID can identify the distributor via a secondary database since the distributor has a close relationship with the detecting device.

In one embodiment, the content identifier 305 and context information 106 are packaged into an efficient binary representation, of which many methods are well known by one of ordinary skill in the art. For example, this package may include 32 bits for the content ID 305 and 32 bits for a distributor ID, the equivalent of 8 characters. In an alternative embodiment, the package may have a total length of 8-32 characters.

The content ID 305 and context information 306 package is checked to determine if interactive data 350 exists in the detecting device's cache 320. The cache 320 may have been loaded with the interactive data 350 before a content identifier trigger arrived, most likely sent via a forward broadcast channel 360, possibly via a private digital MPEG metadata stream or analog VBI lines 11 to 21. If the interactive information 350 exists in the cache 320, a corresponding action is taken (e.g., link to a website via a provided URL).

The proper action is most likely displaying the interactive information 350 on the TV screen. Alternatively, the detecting device 310 could send the interactive information 350 to a personal display via a transmitter. In another configuration, the interactive data 350 may be a name and phone number (e.g., inherently known by the detecting device) and sent directly to an advertiser to order sell their product, such as ordering a pizza for delivery.

The interactive data 350 can also be a web page or a group of web pages. The web page or group may or may not link to remote web pages. When web pages do not link outside of themselves (this is known as a walled garden) and the back channel bandwidth is not used to request new links.

If the interactive data 350 is not in the cache 320 or if the cache 320 does not exist, the content ID 305 and context information 306 package is sent to central servers 340 via back channel 330. The central servers 340 can locate the link to the interactive data 350 or the interactive data 350 itself via the content ID 305 and context information 306, as described above.

After retrieving the desired interactive data, the central servers 340 return it to the detecting device 300, which act appropriately. Most likely the detecting device displays the information on the TV screen for interaction. It may also transmit it to a personal display device, possibly a web pad, for interaction.

Once the initial interactive data is accessed, the end user interacts with corresponding interactive content and the information can take them many locations on the network or the interactive content may be self-contained, known as a walled garden.

In another alternative configuration, a distributor, such as a cable operator, or any other member of a value chain embeds another watermark layer with their ID. This additional ID can be read by the detector and sent to the cache 320 or central servers 340 for proper handling. This method allows the content ID 305 to be forwarded to a secondary database managed by the content owner, separate from the central server 340, thus acting as a router. In either configuration, the content ID 305 can use the secondary database to identify not only the content, but also any additional information that the content owners desire, such as content creation, publisher, performer, actors, publication date, creation location, artist, album, and lyrics.

Likewise on the consumer side, a watermark detector is provided at a low level layer, serving to analyze the received video data for watermark information, and relay the decoded watermark information to higher layers that make use of such auxiliary information in augmenting the consumer's experience. (The video watermark decoder can be provided at the lowest—physical—layer, or at a higher level.)

Through arrangements like those detailed above, interactive TV employs watermark data—conveyed “in-band” in image content—to augment the consumer's experience. Rather than implementing the technology differently for every origination system and set top box hardware (and associated STB operating system) on the market, the watermark functionality is desirably incorporated into a pre-existing layered communication architecture. By such approach, the installed based of content authoring tools, clients, and content is un-affected, and implementation is greatly simplified.

Searching

Know web crawlers often build databases detailing the location of content. Such a database could be then used as an electronic programming guide (EPG). As discussed above, the EPG may include content identifiers for various applications.

EPGs can also be pushed down to various STB. The EPG and a watermark detector when interfaced enable synchronization of the EPG to what is really being broadcast. Thus the EPG possesses a self-correction feature.

Set-Top Box as Central Decoder

The set-top box (STB) illustrated in FIG. 2 lends itself to serve as a central digital watermark decoder and interactive station. For example, a personal computer, VCR, DVD, PVR, digital camera, web cam, scanner, optical reader, or other audio/video/image capture or replay device may be connected to the STB (see FIG. 12). The STB is then used as a central watermark interactivity center. For example, content from a VCR may include content identifiers, and such identifiers may be used to index corresponding interactive data. In this regard, content played via a DVD or VCR becomes interactive. Similarly, printed materials from a scanner or web cam may create an interactive experience as well. Such variations are within the scope of the present invention.

In the current analog home, for a STB to detect a digital watermark, the VCR signal is preferably communicated through the STB to a TV. In one digital system implementation, there preferably includes a two-way digital communication between the STB (in this case also referred to as a gateway) and the VCR or other digital or analog video signal, so that the STB/gateway can detect the signal.

ATVEF Trigger

As will be appreciated in view of this disclosure, the content identifier may be used as an ATVEF compliant trigger. As such, a digital watermark may trigger investigation or searching of a database. Such enhancements are within the scope of the present invention.

STBs and File Sharing

When a STB records content onto a hard drive (e.g., as is the case with a personal video recorder—or PVR) and the STB has an Internet connection (e.g., a broadband connection), various STBs (or computers) can share previously recorded (and stored) programming. For example, if Joe missed his favorite show and forgot to record it, he might find it on Sue's STB, download it, and watch it the next day just like he recorded it, even with commercials. Unique identifiers, especially when integrated with the EPG, can help this system catalog and track program on a network. In addition, the identifiers when provided in a digital watermark can guarantee that the content is authentic such as safe and free from content bombs. These inventive techniques are even further discussed in assignee's U.S. patent application Ser. Nos. 09/620,019, filed Jul. 20, 2000, and 09/952,384, filed Sep. 11, 2001 and in assignee's PCT application No. PCT/US01/22953, filed Jul. 20, 2000. Each of these applications is herein incorporated by reference.

### CONCLUSION

To provide a comprehensive disclosure without unduly lengthening this specification, the patents and applications cited above are incorporated herein by references, together with application Ser. No. 09/571,422, filed May 15, 2000.

Having described and illustrated the principles of the invention with reference to illustrative embodiments, it should be recognized that the invention is not so limited.

For example, while the specification referred to a few examples of digital watermarking technology, the field is broad and growing. Any watermarking technology capable of communicating a sufficient payload (e.g., for a content identifier) can be employed. In addition, out-of-band technology can be used in conjunction with a digital watermark to carry an identifier.

The implementation of the functionality described above (including watermark decoding) is straightforward to artisans in the field, and thus not further belabored here. Conventionally, such technology is implemented by suitable software, stored in long-term memory (e.g., disk, ROM, etc.), and transferred to temporary memory (e.g., RAM) for execution on an associated CPU. In other implementations, the functionality can be achieved by dedicated hardware, or by a combination of hardware and software. Reprogrammable logic, including FPGAs, can advantageously be employed in certain implementations.

It should be recognized that the particular combinations of elements and features in the above-detailed embodiments are exemplary only; the interchanging and substitution of these teachings with other teachings in this and the incorporated-by-reference patents/applications are also contemplated.

Of course, it will be recognized that the term “communicate” is not necessarily limited to direct communication. Instead, such communication may be facilitated via a router(s), buffers, amplifiers, network, cache, etc.

The above section headings provide no substantive limitations, and are merely provided for convenience. It will be appreciated that the features and elements discussed under a first section heading may be combined or interchanged with features discussed in a second section heading.

The above-described methods and functionality can be facilitated with computer executable software stored on computer readable mediums, such as electronic memory circuits, RAM, ROM, magnetic media, optical media, removable media, etc. Such software may be stored on a user site, and/or distributed throughout a network. Data structures representing the various data strings may also be stored on such computer readable mediums.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

What is claimed is:

1. An interactive television system for providing content, the content including identifiers, said system comprising:
a set-top box including a content identifier detector;
at least one database comprising a mapping of content identifiers to interactive data; and
a channel to access interactive content via the interactive data.

2. A system according to claim 1, wherein a digital watermark comprises the content identifier.

3. A system according to claim 2, wherein the digital watermark comprises a payload including the content identifier.

4. A system according to claim 2, wherein the content comprises context information.

5. A system according to claim 4, wherein the context information comprises key words.

6. A system according to claim 5, wherein the key words are used to identify interactive data.

7. An interactive television system for providing content, the content including identifiers, said system comprising:
a content receiver including a content identifier detector, the detector comprising a digital watermark decoder;
a central database including a set of content identifiers and corresponding interactive data; and
a distributed router in communication with a database, said database maintaining a subset of the content identifiers and corresponding interactive data.

8. An interactive television system for providing content, the content including identifiers, said system comprising:
a content broadcast source;
a content receiver;
at least one router in communication with a database, the database including a mapping of content identifier to interactive data, wherein the interactive data is pushed to said content receiver.

9. The system according to claim 8, wherein a digital watermark comprises at least one of the content identifiers.

10. The system according to claim 9, wherein the interactive data is pushed from the router to the content receiver.

11. The system according to claim 9, wherein the interactive data is pushed from the broadcast source to the receiver.

12. A method of supplying interactive data comprising the steps of:
indexing interactive data according to a corresponding content identifier;
storing subsets of the interactive data in distributed routers; and
accessing a subset of interactive data from a lowest cost router.

13. The method according to claim 12, wherein the lowest cost router is a router having the shortest access time.

14. The method according to claim 13, wherein a digital watermark component comprises the content identifier.

15. A method of operating an interactive television system comprising the steps of:
associated interactive data with content identifiers; and
providing the interactive data to a content receiver in advance of corresponding content.

16. The method of claim 15, wherein at least one of the content identifiers is embedded in the corresponding content via a digital watermark.

17. A method according to claim 16, wherein the content receiver comprises a set-top box.

18. A method according to claim 16, wherein the content receiver comprises a distributed router.

19. A method according to claim 16, further comprising the step of providing interactive content to the content receiver in advance of the corresponding content.

20. An interactive television system for distributing content including an identifier, said system comprising:
a cable head end to receive the content, the content including an embedded digital watermark comprising an identifier, said cable head end comprising:
a digital watermark detector to extract the identifier from the received content;
a bridge to communicate the extracted identifier to a database, the database including a trigger indexed according to the identifier, said bridge to receive a corresponding trigger identified in the database as corresponding to the identifier; and
an inserter communicating with said bridge to insert the trigger into the received content.

21. The interactive television system according to claim 20, wherein said inserter communicates with at least a set-top box.

22. The interactive television system according to claim 20, wherein said cable head end communicates the trigger to a network and receives from the network related content.

23. The interactive television system according to claim 22, wherein the related content comprises interactive content.

24. The interactive television system according to claim 22, wherein the related content comprises one of a web page, HTML code, Java applet, audio, visual, graphic, and text.

25. The interactive television system according to claim 22, wherein said inserter inserts the related content into the received content.

26. An interactive television system for distributing content embedded with unique identifiers, said system comprising:
a cable head end to receive content steganographically embedded with a unique identifier, said cable head end comprising an aggregator in communication with at least one set-top box and with a database, said aggregator communicating the unique identifier once extracted from the content from the set-top box to the database, and communicating related interactive data from the database to the set-top box.

27. The system according to claim 26, wherein said aggregator communicates with a plurality of set-top boxes, and wherein said aggregator multicasts the related interactive data to the set-top boxes.

28. The system according to claim 26, wherein the embedding comprises a digital watermark.

29. A method of operating an interactive television system comprising the steps of:
registering content to obtain at least one unique identifier for the content, and upon registration, storing the unique identifier in a database and associating interactive data with the unique identifier;
digitally watermarking the unique identifier in the content;
distributing the content to at least one set-top box;
in the set-top box, decoding the digital watermark to extract the unique identifier;
communicating the unique identifier to the database to retrieve the associated interactive data; and
in the set-top box, communicating with a network to retrieve interactive content associated with received interactive data.

30. In an interactive television system, a method of indexing a database comprising the steps of:
decoding a digital watermark to extract an identifier; and
communicating the identifier to a database including interactive data indexed according to identifiers.

31. The method according to claim 30, wherein said identifier comprises a unique content identifier.

32. The method according to claim 30, wherein said identifier comprises a time identifier.

33. The method according to claim 32, wherein said time identifier comprises an indication of the relevant time segment for a content item.

34. The method according to claim 30, wherein said identifier further comprises a time identifier.

35. The method according to claim 30, further comprising the step of communicating a detector identifier with the identifier.

36. The method according to claim 35, wherein the detector identifier comprises a distributor identifier and a manufacture identifier.

37. In an interactive television system, a method comprising:
providing an electronic program guide (EPG);
populating the EPG with sets of content identifiers, wherein each set corresponds to a predetermined program.

38. The method of claim 37, wherein a digital watermark includes a content identifier, and the content identifier triggers a response of pushing a set of content identifiers to a set-top box.

39. The method of claim 37, wherein the system comprises a set-top box including memory and a digital watermark decoder, wherein the EPG resides in the set-top box memory, and wherein the decoder decodes a digital watermark embedded in content, the digital watermark including a content identifier, the content identifier being compared with the EPG to verify the EPG.

40. A detecting device for interactive television comprising:
a detector for extracting a content identifier from a VBI of a video signal received via a forward channel, where the content identifier is a binary code used to index related information; and
a communication device for sending the content identifier to a secondary location where the related information is stored via a return channel.

41. The device of claim 40 wherein the detecting device includes a cache for storing related information.

42. The device of claim 41 wherein the cache is operable to receive the related information via the forward channel through which the video signal is received.

43. The device of claim 41 wherein the detector is operable to check the cache for related information before passing the content identifier to the secondary location.

44. The device of claim 41 wherein the cache is operable to store a portion of related information associated with most recently received video signal data in the detecting device.

45. The device of claim 41 wherein the cache is operable to store most recently requested information from the secondary location.

46. The device of claim 40 wherein the content identifier is sent along with context information to the secondary location to index the related information.

47. The device of claim 46 wherein the context information includes information provided by a user.

48. The device of claim 47 wherein the context information includes user preferences provided by the user.

49. The device of claim 46 wherein the context information includes data identifying a distributor, such that related information returned to the is dependent on the distributor.

50. The device of claim 40 including a transmitter for sending the related information to a display device for display to a viewer of the video signal.

51. The device of claim 50 wherein the transmitter is a wireless transmitter for sending the related information to a personal display device.

52. The device of claim 50 wherein the transmitter sends the related information for rendering on a display device where the video signal is being displayed.

53. The device of claim 40 wherein the related information is returned from the secondary location to the device via the return channel.

54. The device of claim 40 wherein the related information is returned from the secondary location to the device via the forward channel.

55. The device of claim 40 including a watermark detector for detecting a digital watermark in the video signal, wherein the digital watermark includes information used to index the related information.

56. The device of claim 50 including a digital watermark detector for detecting a digital watermark in an audio track of the video signal, wherein the digital watermark includes information used to index the related information.
